(19) United States
(12) Patent Application Publication
(10) Pub. No.: US 2025/0229779 A1
(43) Pub. Date: Jul. 17, 2025

(54) VEHICLE CONTROL DEVICE, COMPUTER PROGRAM FOR VEHICLE CONTROL, AND METHOD FOR CONTROLLING VEHICLE

(71) Applicant: TOYOTA JIDOSHA KABUSHIKI KAISHA, Toyota-shi Aichi-ken (JP)

(72) Inventor: Masaaki Yamaoka, Meguro-ku Tokyo-to (JP)

(73) Assignee: TOYOTA JIDOSHA KABUSHIKI KAISHA, Toyota-shi Aichi-ken (JP)

(21) Appl. No.: 19/017,987

(22) Filed: Jan. 13, 2025

(30) Foreign Application Priority Data
Jan. 16, 2024 (JP) 2024-004516

(51) Int. Cl. B60W 30/18

(52) U.S. Cl. CPC B60W 30/18009; B60W 2552/00; B60W 2554/4041; B60W 2554/4042; B60W 2554/4044; B60W 2554/802

(57) ABSTRACT

A vehicle control device has a processor configured to determine whether a forward moving vehicle traveling ahead of a host vehicle and an oncoming vehicle traveling toward the host vehicle are present in a predetermined range in a traveling direction of the host vehicle, to determine whether a narrow road section exists between the forward moving vehicle and the oncoming vehicle where it is difficult for the host vehicle and the oncoming vehicle to travel past each other, when it has been determined that a forward moving vehicle and the oncoming vehicle are present, to determine whether the host vehicle can enter into the narrow road section before the oncoming vehicle, based on a response of the forward moving vehicle to the oncoming vehicle, and to decide that the host vehicle should enter into the narrow road section before the oncoming vehicle.

### CROSS-REFERENCE TO RELATED APPLICATIONS

This application claims priority to Japanese Patent Application No. 2024-004516 filed Jan. 16, 2024, the entire contents of which are herein incorporated by reference.

### FIELD

The present disclosure relates to a vehicle control device, a computer program for vehicle control, and a method for controlling a vehicle.

### BACKGROUND

An in-vehicle automatic control device drives the host vehicle so that the host vehicle travels while maintaining a safe distance between a host vehicle and other vehicles.

When an oncoming vehicle is present, the automatic control device detects the width of the road ahead of the host vehicle, controlling the host vehicle so as to allow the host vehicle and the oncoming vehicle to pass each other at a safe distance (see Japanese Unexamined Patent Publication No. 2020-149204, for example).

Some terrains have narrow road sections where the width of the road is partially narrowed. In a narrow road section it is difficult to travel while allowing the host vehicle and an oncoming vehicle to pass each other at a safe distance.

When a narrow road section is present ahead on the road on which the host vehicle is traveling, a situation arises in which the host vehicle must travel through the narrow road section before the oncoming vehicle, or must yield to the oncoming vehicle for travel through the narrow road section.

### SUMMARY

The judgment of whether to prioritize traveling of the host vehicle or to prioritize traveling of the oncoming vehicle in a narrow road section is also carried out by the oncoming vehicle. When each of the host vehicle and the oncoming vehicle decide to travel through the narrow road section first, and both vehicles enter into the narrow road section, a situation arises in which one of the vehicles must back up to allow the other vehicle to pass.

When a forward moving vehicle is in front of the host vehicle, a response of the forward moving vehicle to the oncoming vehicle may be referred to.

It is therefore an object of the present disclosure to provide a vehicle control device that can accurately determine whether to prioritize traveling of the host vehicle based on the response of a forward moving vehicle to an oncoming vehicle in a narrow road section.

(1) One embodiment of the present disclosure provides a vehicle control device. The vehicle control device has a processor configured to determine whether or not a forward moving vehicle traveling ahead of a host vehicle and an oncoming vehicle traveling toward the host vehicle are present in a predetermined range in a traveling direction of the host vehicle, determine whether or not a narrow road section exists between the forward moving vehicle and the oncoming vehicle where it is difficult for the host vehicle and the oncoming vehicle to travel past each other, when it has been determined that the forward moving vehicle and the oncoming vehicle are present, determine whether or not the host vehicle can enter into the narrow road section before the oncoming vehicle, based on a response of the forward moving vehicle to the oncoming vehicle, when it has been determined that the narrow road section exists, and decide that the host vehicle should enter into the narrow road section before the oncoming vehicle, when it has been determined that the host vehicle can enter into the narrow road section before the oncoming vehicle.

(2) The vehicle control device of the embodiment (1), the processor is further configured to determine whether or not the forward moving vehicle will reach the narrow road section before the oncoming vehicle and the host vehicle can enter into the narrow road section before the forward moving vehicle passes through the narrow road section, and decide that the host vehicle should enter into the narrow road section before the oncoming vehicle, when it has been determined that the forward moving vehicle will reach the narrow road section before the oncoming vehicle and the host vehicle can enter into the narrow road section before the forward moving vehicle passes through the narrow road section.

(3) The vehicle control device of the embodiment (1), the processor is further configured to determine whether or not the forward moving vehicle will reach the narrow road section before the oncoming vehicle and the host vehicle can enter into the narrow road section before the forward moving vehicle passes beside the oncoming vehicle after having passed through the narrow road section, and decide that the host vehicle can enter into the narrow road section before the oncoming vehicle, when it has been determined that the forward moving vehicle will pass through the narrow road section before the oncoming vehicle and the host vehicle can enter into the narrow road section before the forward moving vehicle passes beside the oncoming vehicle after having passed through the narrow road section.

(4) The vehicle control device of the embodiment (1), the processor is further configured to determine whether or not the forward moving vehicle will reach the narrow road section before the oncoming vehicle, the host vehicle can enter into the narrow road section before the forward moving vehicle passes through the narrow road section, and the distance between the forward moving vehicle and the host vehicle is shorter than a predetermined reference distance, and decide that the host vehicle can enter into the narrow road section before the oncoming vehicle, when it has been determined that the forward moving vehicle will pass through the narrow road section before the oncoming vehicle, the host vehicle can enter into the narrow road section before the forward moving vehicle passes through the narrow road section, and the distance between the forward moving vehicle and the host vehicle is shorter than the predetermined reference distance.

(5) The vehicle control device of any one of the embodiments (1) to (4), the processor is further configured to determine whether or not the forward moving vehicle has decelerated beyond a predetermined reference speed amount after it has been decided that the host vehicle can enter into the narrow road section before the oncoming vehicle, determine that the host vehicle cannot enter into the narrow road section before the oncoming vehicle, when it has been determined that the forward moving vehicle has decelerated beyond the predetermined reference speed amount, and decide to cancel the decision allowing the host vehicle to enter into the narrow road section before the oncoming vehicle so that the host vehicle does not enter into the narrow road section before the oncoming vehicle, when it has been determined that the host vehicle cannot enter into the narrow road section before the oncoming vehicle.

(6) The vehicle control device of the embodiment (5), the processor is further configured to determine whether or not the forward moving vehicle has decelerated beyond the predetermined reference speed amount while the forward moving vehicle is traveling in the narrow road section after it has been decided that the host vehicle can enter into the narrow road section before the oncoming vehicle.

(7) According to another embodiment, a computer-readable, non-transitory storage medium is provided which stores a computer program for vehicle control. The computer program for vehicle control causes a processor to execute a process, and the process includes determining whether or not a forward moving vehicle traveling ahead of a host vehicle and an oncoming vehicle traveling toward the host vehicle are present in a predetermined range in a traveling direction of the host vehicle, determining whether or not a narrow road section exists between the forward moving vehicle and the oncoming vehicle where it is difficult for the host vehicle and the oncoming vehicle to travel past each other, when it has been determined that the forward moving vehicle and the oncoming vehicle are present, determining whether or not the host vehicle can enter into the narrow road section before the oncoming vehicle, based on a response of the forward moving vehicle to the oncoming vehicle, when it has been determined that the narrow road section exists, and deciding that the host vehicle should enter into the narrow road section before the oncoming vehicle, when it has been determined that the host vehicle can enter into the narrow road section before the oncoming vehicle.

(8) Another embodiment of the present disclosure provides a method for controlling a vehicle. The method for controlling a vehicle includes determining whether or not a forward moving vehicle traveling ahead of a host vehicle and an oncoming vehicle traveling toward the host vehicle are present in a predetermined range in a traveling direction of the host vehicle, determining whether or not a narrow road section exists between the forward moving vehicle and the oncoming vehicle where it is difficult for the host vehicle and the oncoming vehicle to travel past each other, when it has been determined that the forward moving vehicle and the oncoming vehicle are present, determining whether or not the host vehicle can enter into the narrow road section before the oncoming vehicle, based on a response of the forward moving vehicle to the oncoming vehicle, when it has been determined that the narrow road section exists, and deciding that the host vehicle should enter into the narrow road section before the oncoming vehicle, when it has been determined that the host vehicle can enter into the narrow road section before the oncoming vehicle.

The vehicle control device of the present disclosure can accurately determine whether to prioritize traveling of the host vehicle based on the response of a forward moving vehicle to an oncoming vehicle in a narrow road section.

The object of the present disclosure will be realized and attained by the elements and combinations particularly specified in the claims. It is to be understood that both the foregoing general description and the following detailed description are exemplary and explanatory and are not restrictive of the present disclosure, as claimed.

### BRIEF DESCRIPTION OF DRAWINGS

FIG. 1 is a diagram illustrating operation of a determining device of the embodiment in overview.

FIG. 2 is a hardware configuration diagram for a vehicle in which the determining device of the embodiment is mounted.

FIG. 3 is an example of an operation flow chart for vehicle control processing by the determining device of the embodiment.

FIG. 4 is an example of an operation flow chart for determination processing by a determining device according to the embodiment.

FIG. 5 is an example of an operation flow chart showing a modified example of determination processing by a determining device according to the embodiment.

FIG. 6 is an example of an operation flow chart for decision processing by a modified example of a determining device according to the embodiment.

### DESCRIPTION OF EMBODIMENTS

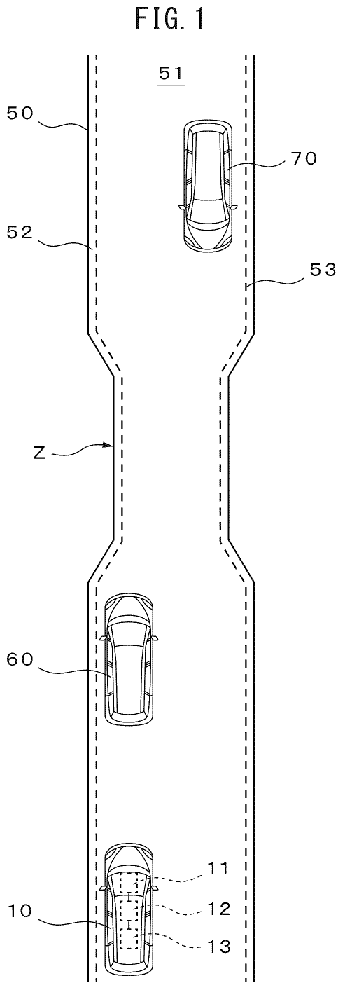

FIG. 1 is a diagram illustrating operation of a determining device 13 of the embodiment in overview. Operation relating to determination processing by a determining device 13 of the embodiment as disclosed herein will now be described in overview with reference to FIG. 1. The determining device 13 is an example of the vehicle control device.

The vehicle 10 is traveling on the road 50, as shown in FIG. 1. The road 50 has a lane 51. The traffic lane 51 is delineated by a lane marking line 52 and a lane marking line 53.

The road 50 has a narrow road section Z with partially narrowing width. In the narrow road section Z, the distance between the lane marking line 52 and the lane marking line 53 is narrowed. It is difficult for two vehicles to pass each other in the narrow road section.

The vehicle 10 has an object detector 11, an automatic control device 12 and a determining device 13. The object detector 11 generates object detection information representing objects such as vehicles in a predetermined range in the traveling direction of the vehicle 10, based on environment information representing the environment surrounding the vehicle 10, obtained by camera images, for example. The object detector 11 also generates road information representing the road in a predetermined range in the traveling direction of the vehicle, based on the environment information.

The automatic control device 12 controls the vehicle 10 based on the object detection information and the road information. The vehicle 10 may also be a self-driving vehicle.

In the example shown in FIG. 1, the determining device 13 determines, based on the object detection information, that a forward moving vehicle 60 traveling in front of the vehicle 10 and an oncoming vehicle 70 traveling toward the vehicle 10 are present within a predetermined range in the traveling direction of the vehicle 10.

The determining device 13 also determines, based on the road information, that a narrow road section Z exists between the forward moving vehicle 60 and the oncoming vehicle 70, where it is difficult for the vehicle 10 and the oncoming vehicle 70 to pass each other.

Based on the response of the forward moving vehicle 60 to the oncoming vehicle 70, the determining device 13 determines whether or not the vehicle 10 can enter into the narrow road section Z before the oncoming vehicle 70. When the oncoming vehicle 70 has yielded to the forward moving vehicle 60 to enter first into the narrow road section Z, it is possible that the oncoming vehicle 70 will also yield to the vehicle 10 to enter first into the narrow road section Z.

For example, when it has been determined that the forward moving vehicle 60 will pass through the narrow road section Z before the oncoming vehicle 70, and that the vehicle 10 can enter into the narrow road section Z before the forward moving vehicle 60 has passed through the narrow road section Z, the determining device 13 decides for the vehicle 10 to enter into the narrow road section Z before the oncoming vehicle 70.

The determining device 13 notifies the automatic control device 12 that the vehicle 10 will enter into the narrow road section Z before the oncoming vehicle 70. The automatic control device 12 controls the vehicle 10 so that the vehicle 10 enters the narrow road section by following the forward moving vehicle 60.

On the other hand, when it has been determined that the forward moving vehicle 60 will pass through the narrow road section Z before the oncoming vehicle 70 but that the vehicle 10 cannot enter into the narrow road section Z before the forward moving vehicle 60 has passed through the narrow road section Z, then the determining device 13 decides that the vehicle 10 will not enter into the narrow road section Z before the oncoming vehicle 70.

In this way the determining device 13 can accurately determine whether to prioritize traveling of the vehicle 10 based on the response of the forward moving vehicle 60 to the oncoming vehicle 70 in the narrow road section Z. This allows the determining device 13 to decide on the order of entering the narrow road section Z for the oncoming vehicle 70 and the vehicle 10.

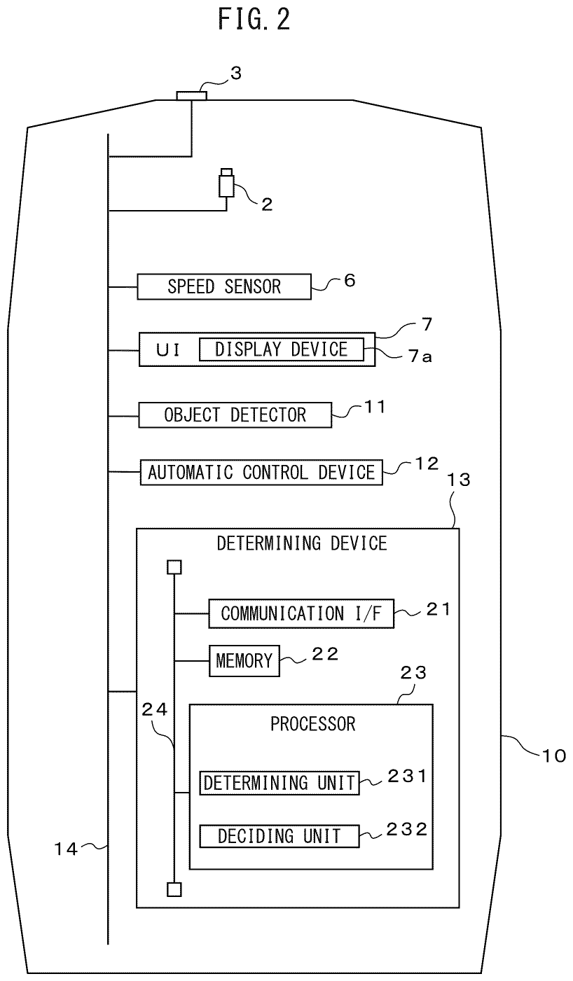

FIG. 2 is a hardware configuration diagram for the vehicle 10 in which the determining device 13 of the embodiment is mounted. The vehicle 10 has a front camera 2, a LiDAR sensor 3, a speed sensor 6, a user interface (UI) 7, an object detector 11, an automatic control device 12 and a determining device 13, etc.

The front camera 2, LiDAR sensor 3, speed sensor 6, UI 7, object detector 11, automatic control device 12 and determining device 13 are connected in a communicable manner via an in-vehicle network 14 conforming to the Controller Area Network standard.

The front camera 2 is an example of an imaging unit provided in the vehicle 10. The front camera 2 is mounted on the vehicle 10 and directed toward the front of the vehicle 10. The front camera 2 acquires a camera image in which the environment of a region in a predetermined visual field ahead of the vehicle 10 is shown, at a camera image acquisition time set with a predetermined cycle, for example. The camera image can show the road in the predetermined region ahead of the vehicle 10, and road features such as surface lane marking lines on the road. The front camera 2 has a 2D detector composed of an array of photoelectric conversion elements with visible light sensitivity, such as a CCD or C-MOS. The front camera 2 also has an imaging optical system that forms an image of the photographing region on the 2D detector. The camera image is an example of environment information. The visual field of the front camera 2 is an example of a predetermined range.

Each time a camera image is acquired, the front camera 2 outputs the camera image and the camera image acquisition time through the in-vehicle network 14 to the object detector 11. At the object detector 11, the camera image is used for processing to detect objects and road features surrounding the vehicle 10.

The LiDAR sensor 3 is mounted on the outer side of the vehicle 10, for example, being directed toward the front of the vehicle 10. The LiDAR sensor 3 emits a scanning laser toward the predetermined visual field in front of the vehicle 10, at a reflected wave information acquisition time set with a predetermined cycle. The LiDAR sensor 3 also receives a reflected wave that has been reflected from a reflector. The information of the time required for the reflected wave to return is also information for the distance between the vehicle 10 and other objects located in the direction in which the laser has been emitted. The LiDAR sensor 3 outputs the reflected wave information, together with the reflected wave information acquisition time at which the laser was emitted, through the in-vehicle network 14 to the object detector 11. The reflected wave information includes the direction in which the laser is emitted and the time required for the reflected wave to return. The reflected wave information acquisition time represents the time at which the laser was emitted. At the object detector 11, the reflected wave information is used for processing to detect objects surrounding the vehicle 10. In some embodiments, the visual field of the LiDAR sensor 3 overlaps with the visual field of the front camera 2.

The speed sensor 6 detects speed information representing the speed of the vehicle 10. The speed sensor 6 has a measuring device that measures the rotational speed of the tire of the vehicle 10. The speed sensor 6 outputs the speed information to the object detector 11, automatic control device 12 and determining device 13, etc. via the in-vehicle network 14. The speed information is used for processing by the object detector 11, automatic control device 12 and determining device 13 to calculate the speed of the vehicle 10.

The UI 7 is an example of the notification unit. The UI 7, controlled by the automatic control device 12 and determining device 13, etc., notifies the driver of the vehicle 10 traveling information and warnings. The vehicle 10 traveling information includes the current location of the vehicle, and notifications to the driver. The UI 7 has a display device 7a such as a liquid crystal display or touch panel, for display of the traveling information. The UI 7 may also have an acoustic output device (not shown) to notify the driver of traveling information.

The object detector 11 detects objects around the vehicle 10, and their types, based on the camera image. Objects also include moving objects such as pedestrians and vehicles. The object detector 11 also detects road features such as lane marking lines, based on camera images. The object detector 11 may also detect road edges.

The object detector 11 has a classifier that detects objects and road features represented in images, by inputting camera images, for example. The classifier may use a deep neural network (DNN) that has been previously trained to detect objects and road features represented in input images, for example. The object detector 11 used may also be a classifier other than a DNN.

The object detector 11 may also detect objects around the vehicle 10 based on reflected wave information. The object detector 11 may also determine the orientation of an object with respect to the vehicle 10 based on the location of the object in the camera images, and may determine the distance between the object and the vehicle 10, based on the orientation and the reflected wave information. The location of an object represents the location representative of that object (such as its center of gravity). For example, the object detector 11 estimates the location of the object represented in a vehicle coordinate system, based on the current location of the vehicle 10, and the distance of the object from the vehicle 10 and its orientation. The object detector 11 may also track an object to be detected from an updated image, by matching objects detected in the updated camera image with objects detected in previous images, according to a tracking process based on optical flow. The tracked object is assigned an object identification number. The object detector 11 may also calculate the trajectory of an object being tracked, based on the location of the object in an image updated from a previous image. The object detector 11 can estimate the speed of an object with respect to the vehicle 10, based on changes in the location of the object over the course of time. The object detector 11 can also estimate the acceleration of an object based on changes in the speed of the object over the course of time. The object detector 11 may also calculate the locations of road features in the manner described above. The locations of road features are represented on a vehicle coordinate system, for example.

The object detector 11 notifies the automatic control device 12, etc. of object detection information including information representing the object, and road feature information representing road features. The object detection information includes information indicating the type of object that was detected, information indicating its location, and information indicating its speed, acceleration and traveling lane. The object detection information also includes the object identification number of the tracked object. The object detector 11 outputs the road information including the location of lane marking lines representing the road, to the determining device 13 via the in-vehicle network 14.

The automatic control device 12 controls operation of the vehicle 10. The automatic control device 12 has a self-driving mode in which the vehicle 10 is driven by automatic control, and a manual driving mode in which operation of the vehicle 10 is controlled based on driver manipulation. In self-driving mode, the vehicle 10 is driven primarily by the automatic control device 12. In self-driving mode, the automatic control device 12 controls operations such as steering, actuation and braking based on information detected from the front camera 2 and LiDAR sensor 3 mounted in the vehicle 10.

The automatic control device 12 acquires the current location of the vehicle 10 based on positioning information such as GNSS information. The automatic control device 12 operates the vehicle 10 based on a navigation route that has been generated based on the current location of the vehicle 10, the destination location and a navigation map.

In manual driving mode, the vehicle 10 is driven primarily by the driver. In manual driving mode, the automatic control device 12 controls operation of the vehicle 10 such as steering, actuation and braking, based on operation of the steering wheel, brake pedal or accelerator pedal (not shown) by the driver. In manual driving mode, the automatic control device 12 controls operation of the vehicle 10 based on operation of at least one from among the steering wheel, brake pedal and accelerator pedal by the driver.

The automatic control device 12 outputs a control signal for control of steering to a steering device (not shown), via the in-vehicle network 14. The automatic control device 12 outputs a driving signal for control of actuation to a drive unit (not shown), via the in-vehicle network 14. The automatic control device 12 also outputs a braking signal for control of braking to a braking device (not shown), via the in-vehicle network 14. The steering signal for control of steering, the driving signal for control of actuation and the braking signal for control of braking are examples of information representing operation of the vehicle.

The determining device 13 carries out determination processing and decision processing. For this purpose, the determining device 13 has a communication interface (IF) 21, a memory 22 and a processor 23. The communication interface 21, memory 22 and processor 23 are connected via signal wires 24. The communication interface 21 has an interface circuit to connect the determining device 13 with the in-vehicle network 14.

The memory 22 is an example of a storage unit, and it has a volatile semiconductor memory and a non-volatile semiconductor memory, for example. The memory 22 stores an application computer program and various data to be used for information processing carried out by the processor 23. The memory 22 stores the dimensions of the vehicle, such as the width and length of the vehicle 10.

All or some of the functions of the determining device 13 are functional modules driven by a computer program operating on the processor 23, for example. The processor 23 has a determining unit 231 and a deciding unit 232. Alternatively, the functional module of the processor 23 may be a specialized computing circuit in the processor 23. The processor 23 has one or more CPUs (Central Processing Units) and their peripheral circuits. The processor 23 may also have other computing circuits such as a logical operation unit, numerical calculation unit or graphics processing unit.

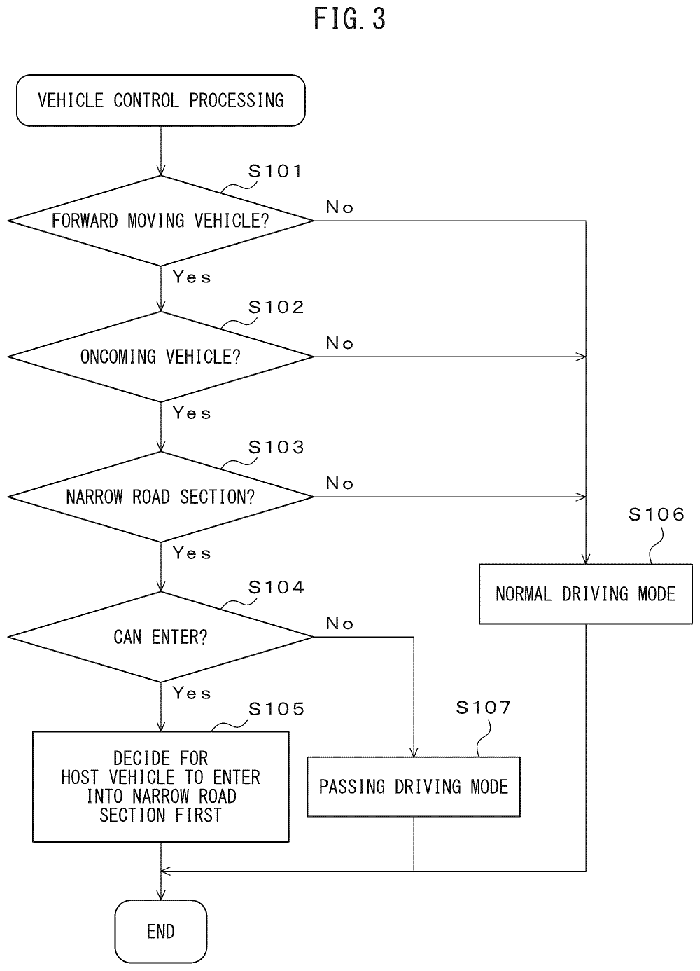

FIG. 3 is an example of an operation flow chart for vehicle control processing by the determining device 13 of the embodiment. Vehicle control processing by the determining device 13 will now be described with reference to FIG. 3. The determining device 13 carries out vehicle control processing according to the operation flow chart shown in FIG. 3, at a vehicle control time having a predetermined cycle.

First, the determining unit 231 determines whether or not a forward moving vehicle is present which is traveling in front of the vehicle 10 (step S101). The determining unit 231 determines whether or not a forward moving vehicle is present based on object detection information. When another vehicle is present in the traveling direction of the vehicle 10 with respect to the current location of the vehicle 10, the determining unit 231 determines that a forward moving vehicle is present.

When another vehicle is located ahead of the vehicle 10 and is moving in the same direction as the traveling direction of the vehicle 10, the determining unit 231 determines that a forward moving vehicle is present. The determining unit 231 is an example of the first determining unit.

When a forward moving vehicle is present (step S101—Yes), the determining unit 231 determines whether or not an oncoming vehicle is present traveling toward the vehicle 10 (step S102). The determining unit 231 determines whether or not an oncoming vehicle is present based on object detection information. When another vehicle is located ahead of the vehicle 10 and is moving in the opposite direction from the traveling direction of the vehicle 10, the determining unit 231 determines that an oncoming vehicle is present. When the distance between the oncoming vehicle and the vehicle 10 is shorter than a predetermined reference distance, the determining unit 231 may determine that an oncoming vehicle is present. The reference distance may be 10 m to 50 m, for example.

When an oncoming vehicle is present (step S102—Yes), the determining unit 231 determines whether or not a narrow road section exists between the forward moving vehicle and the oncoming vehicle, where it is difficult for the vehicle 10 and the oncoming vehicle to pass each other (step S103). The determining unit 231 is an example of a second determining unit.

The determining unit 231 detects a narrow road section in a predetermined range in the traveling direction of the vehicle 10 based on the road information. The predetermined range used may be the visual field of the front camera 2. First, the determining unit 231 calculates the width of the road on which the vehicle 10 is traveling, based on the road information. The width of the road may be the distance between the nearest lane marking line to one road edge and the nearest lane marking line to the other road edge. In the example shown in FIG. 1, the distance between the lane marking line 52 and the lane marking line 53 is the width of the road. When lane marking lines have not been detected, the distance between opposite road edges may be used as the width of the road. When the determining unit 231 has a high-precision map for the road on which the vehicle 10 is traveling, the determining unit 231 may detect a narrow road section based on the current location of the vehicle 10 and the high-precision map.

The determining unit 231 detects a narrow road section as being any section where the road width is equal to or less than a predetermined reference width. The reference width is a road width where it is difficult for two vehicles to travel past each other. The reference width may be 4 m to 4.5 m, for example. The determining unit 231 may also set the reference width based on the width of the vehicle 10 stored in the memory 22. The reference width in this case may be 2.5 times the width of the vehicle 10.

When a narrow road section has been detected, the determining unit 231 determines whether or not the location of the narrow road section is between a forward moving vehicle and an oncoming vehicle, based on object detection information. When the location of the narrow road section is between a forward moving vehicle and an oncoming vehicle, the determining unit 231 determines that a narrow road section exists between the forward moving vehicle and the oncoming vehicle.

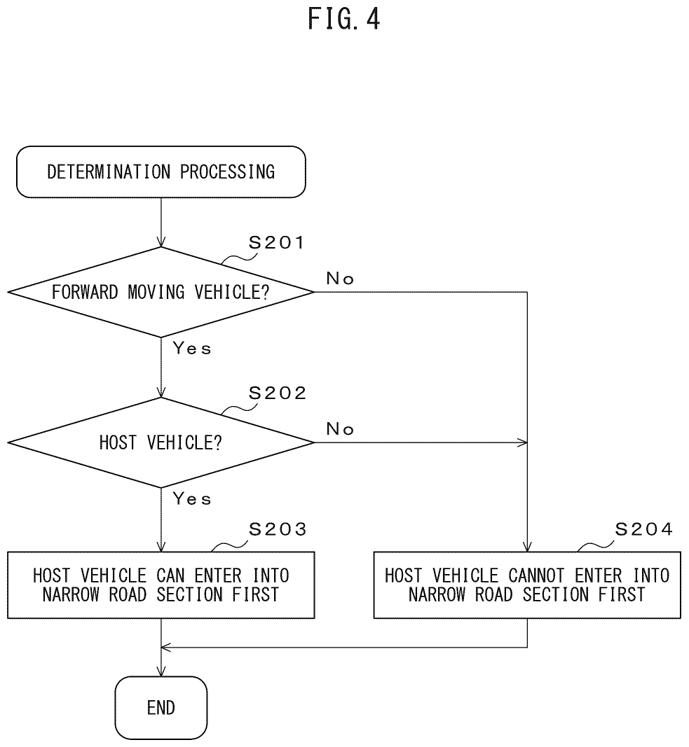

When a narrow road section exists between the forward moving vehicle and the oncoming vehicle (step S103—Yes), the determining unit 231 determines whether or not the vehicle 10 can enter into the narrow road section before the oncoming vehicle, based on the response of the forward moving vehicle to the oncoming vehicle (step S104). The determining unit 231 is an example of a third determining unit. Determination processing in step S104 will be explained in detail below with reference to FIG. 4.

When it has been determined that the vehicle 10 can enter into the narrow road section before the oncoming vehicle (step S104—Yes), the deciding unit 232 decides that the vehicle 10 (host vehicle) should enter the narrow road section before the oncoming vehicle (step S105), and the series of processing steps is complete. The deciding unit 232 notifies the automatic control device 12 that the vehicle 10 will enter into the narrow road section before the oncoming vehicle. The automatic control device 12 then controls the vehicle 10 so that the vehicle 10 enters the narrow road section by following the forward moving vehicle.

On the other hand, when no forward moving vehicle is present (step S101—No), no oncoming vehicle is present (step S102—No) or no narrow road section exists between the forward moving vehicle and oncoming vehicle (step S103—No), the deciding unit 232 decides to control the vehicle 10 in normal driving mode (step S106), and the series of processing steps is complete. The deciding unit 232 notifies the automatic control device 12 that the vehicle 10 is to be controlled in normal driving mode.

In normal driving mode, the automatic control device 12 controls the vehicle 10 so as to maintain a safe distance between the vehicle 10 and objects such as forward moving vehicles and oncoming vehicles. When an oncoming vehicle is present and a narrow road section exists between the oncoming vehicle and the vehicle 10, the automatic control device 12 may control the vehicle 10 in “passing driving mode”. In passing driving mode, it is estimated which of the vehicle 10 or oncoming vehicle is the vehicle that will enter the narrow road section first, and the vehicle estimated to enter the narrow road section first is allowed to travel first into the narrow road section.

When it has been determined that the vehicle 10 (host vehicle) cannot enter into the narrow road section before the oncoming vehicle (step S104—No), the deciding unit 232 decides to control the vehicle 10 in passing driving mode (step S107), and the series of processing steps is complete. The deciding unit 232 notifies the automatic control device 12 that the vehicle 10 is to be controlled in passing driving mode.

In passing driving mode, for example, when it has been estimated that an oncoming vehicle is to enter first into the narrow road section, the automatic control device 12 controls the vehicle 10 so that the vehicle 10 enters the narrow road section after the oncoming vehicle 70 has passed through the narrow road section.

The determination processing of step S104 described above will now be explained with reference to FIG. 4. FIG. 4 is an example of an operation flow chart for determination processing by a determining device 13 according to the embodiment. The determining device 13 carries out determination processing according to the operation flow chart shown in FIG. 4.

First, the determining unit 231 determines whether or not the forward moving vehicle is to reach the narrow road section before the oncoming vehicle, based on the past speeds of the forward moving vehicle, oncoming vehicle and vehicle 10 during a predetermined period (step S201).

The determining unit 231 acquires the current location of the forward moving vehicle and the current location of the oncoming vehicle, based on object detection information. The determining unit 231 calculates the distance between the forward moving vehicle and the narrow road section. The determining unit 231 also calculates the distance between the oncoming vehicle and the narrow road section.

The determining unit 231 calculates the time required for the forward moving vehicle to reach the narrow road section from the current location, assuming the forward moving vehicle will have traveled at the current speed. The current speed of the forward moving vehicle may be the most recent average speed of the forward moving vehicle (for example, from 5 seconds to 10 seconds).

The determining unit 231 also calculates the time required for the oncoming vehicle to reach the narrow road section from the current location, assuming the oncoming vehicle will have traveled at the current speed. The current speed of the oncoming vehicle may be the most recent average speed of the oncoming vehicle (for example, for 5 seconds).

When the time required for the forward moving vehicle to reach the narrow road section is shorter than the time required for the oncoming vehicle to reach the narrow road section, the determining unit 231 determines that the forward moving vehicle will reach the narrow road section before the oncoming vehicle.

On the other hand, when the time required for the forward moving vehicle to reach the narrow road section is equal to or longer than the time required for the oncoming vehicle to reach the narrow road section, the determining unit 231 determines that the forward moving vehicle will not reach the narrow road section before the oncoming vehicle.

When the forward moving vehicle will reach the narrow road section before the oncoming vehicle (step S201—Yes), the determining unit 231 determines whether or not the vehicle 10 can enter into the narrow road section before the forward moving vehicle passes through the narrow road section (step S202).

The determining unit 231 calculates a first time required for the forward moving vehicle to pass through the narrow road section from the current location, assuming the forward moving vehicle will have traveled at the current speed. The current speed of the forward moving vehicle may be the most recent average speed of the forward moving vehicle (for example, for 5 seconds).

The determining unit 231 also calculates a second time required for the vehicle 10 to reach the narrow road section from the current location, assuming the vehicle 10 will have traveled at the current speed. The current speed of the vehicle 10 may be the most recent average speed of the vehicle 10 (for example, for 5 seconds).

When the second time is shorter than the first time, the determining unit 231 determines that the vehicle 10 can enter into the narrow road section before the forward moving vehicle passes through the narrow road section. When the second time is equal to or longer than the first time, on the other hand, the determining unit 231 determines that the vehicle 10 cannot enter into the narrow road section before the forward moving vehicle passes through the narrow road section.

When the vehicle 10 can enter into the narrow road section before the forward moving vehicle passes through the narrow road section (step S202—Yes), the determining unit 231 determines that the vehicle 10 (host vehicle) can enter into the narrow road section before the oncoming vehicle (step S203), and the series of processing steps is complete.

When the forward moving vehicle cannot reach the narrow road section before the oncoming vehicle (step S201—No), or the vehicle 10 cannot enter into the narrow road section before the forward moving vehicle passes through the narrow road section (step S202—No), on the other hand, the determining unit 231 determines that the vehicle 10 (host vehicle) cannot enter into the narrow road section before the oncoming vehicle (step S204), and the series of processing steps is complete.

Modified Example 1 and Modified Example 2 of the determination processing described above will now be explained. First, in step S202 of Modified Example 1 of the determination processing, the determining unit 231 determines whether or not the vehicle 10 can enter into the narrow road section before the forward moving vehicle that has passed through the narrow road section passes beside the oncoming vehicle.

The determining unit 231 calculates a third time required for the forward moving vehicle to pass beside the oncoming vehicle from the current location, assuming the forward moving vehicle will have traveled at the current speed. The third time is calculated with the assumption that the oncoming vehicle will travel to the narrow road section at the current speed of the oncoming vehicle, stopping briefly before the narrow road section. The current speed of the oncoming vehicle may be the most recent average speed of the oncoming vehicle (for example, for 5 seconds). The third time represents, for example, the time required for the location representative of the forward moving vehicle 10 (for example, its center of gravity) to pass through the location representative of the oncoming vehicle (for example, its center of gravity). The determining unit 231 also calculates a fourth time required for the vehicle 10 to reach the narrow road section from the current location, assuming the vehicle 10 will have traveled at the current speed.

When the fourth time is shorter than the third time, the determining unit 231 determines that the vehicle 10 can enter into the narrow road section before the forward moving vehicle passes beside the oncoming vehicle after having passed through the narrow road section. When the fourth time is equal to or longer than the third time, on the other hand, the determining unit 231 determines that the vehicle 10 cannot enter into the narrow road section before the forward moving vehicle passes beside the oncoming vehicle after having passed through the narrow road section.

In some cases, the third time required for the forward moving vehicle to pass beside the oncoming vehicle from its current location may be longer than the first time required for the forward moving vehicle to pass through the narrow road section from its current location. With this modified example, the proposition that the oncoming vehicle may yield to the vehicle 10 to travel first into the narrow road section is considered more valid.

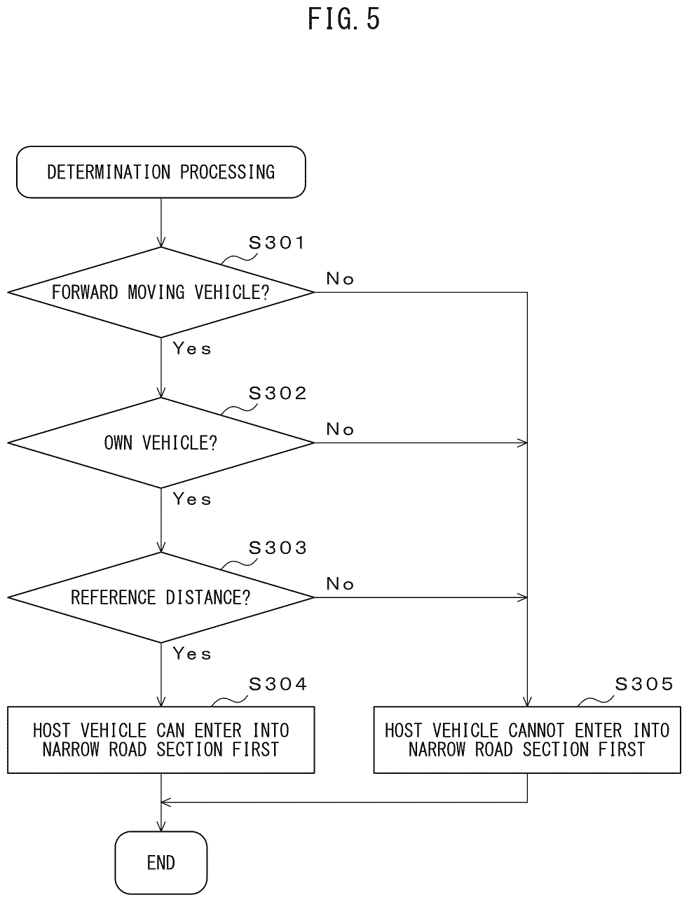

Modified Example 2 of determination processing will now be described with reference to FIG. 5. FIG. 5 is an example of an operation flow chart showing Modified Example 2 of determination processing by a determining device 13 according to the embodiment. This Modified Example 2 of determination processing differs from the operation flow chart shown in FIG. 4 in that the processing of step S303 is added. The processing of steps S301, S302, S304 and S305 are the same as steps S201 to S204.

When the vehicle 10 can enter into the narrow road section before the forward moving vehicle reaches the narrow road section (step S302—Yes), the determining unit 231 determines whether or not the distance between the forward moving vehicle and the vehicle 10 is shorter than a predetermined reference distance (step S303). The determining unit 231 calculates the distance between the forward moving vehicle and the vehicle 10 based on the current location of the vehicle 10 and location of the forward moving vehicle, and compares it with the reference distance. The predetermined reference distance may be 3 m to 10 m, for example. When the distance between the forward moving vehicle and vehicle 10 is long, it is more likely that the oncoming vehicle will enter into the narrow road section before the vehicle 10. When the distance between the forward moving vehicle and vehicle 10 is short, on the other hand, it is more likely that the oncoming vehicle will yield to the vehicle 10 to enter first into the narrow road section.

When the distance between the forward moving vehicle and the vehicle 10 is shorter than the reference distance (step S303—Yes), the determining unit 231 determines that the vehicle 10 can enter the narrow road section before the oncoming vehicle (step S304), and the series of processing steps is complete.

When the distance between the forward moving vehicle and the vehicle 10 is not shorter than the predetermined reference distance (step S303—No), on the other hand, the determining unit 231 determines that the vehicle 10 cannot enter the narrow road section before the oncoming vehicle (step S305), and the series of processing steps is complete.

As explained above, the determining device of the embodiment can accurately determine whether to prioritize traveling of the host vehicle based on the response of a forward moving vehicle to an oncoming vehicle in a narrow road section.

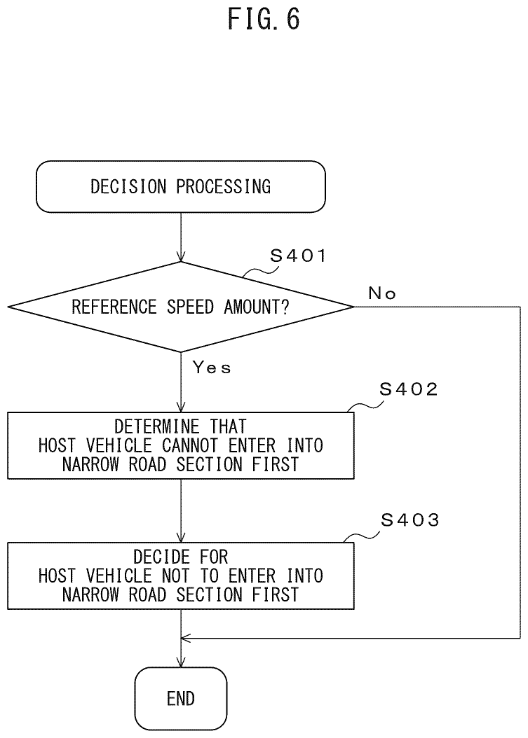

A modified example of the determining device of this embodiment will now be described with reference to FIG. 6. FIG. 6 is an example of an operation flow chart related to decision processing by a modified example of the determining device 13 of the embodiment.

For this modified example, the determining device 13 carries out the decision processing shown in FIG. 6 after having decided that the vehicle 10 is to enter into the narrow road section before the oncoming vehicle. The determining device 13 carries out decision processing according to the operation flow chart shown in FIG. 6 at a decision time having a predetermined cycle, until the vehicle 10 enters into the narrow road section.

First, the determining unit 231 determines whether or not the forward moving vehicle has decelerated beyond a predetermined reference speed amount (step S401). The reference speed amount may be in the range of 5 km/h to 10 km/h, for example. The determining unit 231 ascertains the speed of the forward moving vehicle based on object detection information. The determining unit 231 determines whether or not the speed of the forward moving vehicle has decelerated beyond the reference speed amount, with respect to the speed of the forward moving vehicle at the point where it has been decided that the vehicle 10 can enter into the narrow road section before the oncoming vehicle. The determining unit 231 is an example of a fourth determining unit.

The determining unit 231 may also determine whether or not the forward moving vehicle has decelerated beyond the reference speed amount while the forward moving vehicle is traveling through the narrow road section.

When the forward moving vehicle has decelerated beyond the reference speed amount (step S401—Yes), the determining unit 231 determines that the vehicle 10 cannot enter the narrow road section before the oncoming vehicle (step S402). The determining unit 231 is an example of a fifth determining unit.

The deciding unit 232 then decides that the vehicle 10 should not enter the narrow road section before the oncoming vehicle (step S403), and the series of processing steps is complete. The deciding unit 232 cancels the decision which allows the vehicle 10 to enter the narrow road section before the oncoming vehicle. The deciding unit 232 notifies the automatic control device 12 that the vehicle 10 is to be controlled in passing driving mode.

The reason for a large reduction in speed by the forward moving vehicle may be that the oncoming vehicle is attempting to enter the narrow road section. When the forward moving vehicle has decelerated beyond the reference speed amount, the determining device 13 cancels the decision allowing the vehicle 10 to enter the narrow road section before the oncoming vehicle. This can help ensure safety for the vehicle 10.

The vehicle control device, the computer program for vehicle control and the method for controlling a vehicle according to the embodiments described above may incorporate appropriate modifications that are still within the gist of the disclosure. Moreover, the technical scope of the disclosure is not limited to these embodiments, and includes the present disclosure and its equivalents as laid out in the Claims.

For example, while one front camera was disposed at the front of the vehicle in the embodiment described above, front cameras may also be disposed at both the left and right at the front of the vehicle. This will allow vehicles and road features surrounding the vehicle to be detected with greater accuracy.

Similarly, while one LiDAR sensor was disposed at the front of the vehicle in the embodiment described above, LiDAR sensors may also be disposed at both the left and right at the front of the vehicle. This will likewise allow vehicles and road features surrounding the vehicle to be detected with greater accuracy.

Moreover, while the distances between the host vehicle and objects were measured using a LiDAR sensor in the embodiment described above, the distances between the host vehicle and objects may also be measured using stereo cameras. The camera images acquired from the cameras may also be input to a classifier trained to estimate distances between vehicles and objects in images, for calculation of distances from the vehicle to objects.

Operation of the determining device for the embodiment described above was explained in terms of self-driving mode, but the determining device may also be used in manual driving mode. In manual driving mode, the driver may be notified of decisions by the deciding unit via a user interface.

1. A vehicle control device comprising:
a processor configured to
determine whether or not a forward moving vehicle traveling ahead of a host vehicle and an oncoming vehicle traveling toward the host vehicle are present in a predetermined range in a traveling direction of the host vehicle,
determine whether or not a narrow road section exists between the forward moving vehicle and the oncoming vehicle where it is difficult for the host vehicle and the oncoming vehicle to travel past each other, when it has been determined that the forward moving vehicle and the oncoming vehicle are present,
determine whether or not the host vehicle can enter into the narrow road section before the oncoming vehicle, based on a response of the forward moving vehicle to the oncoming vehicle, when it has been determined that the narrow road section exists, and
decide that the host vehicle should enter into the narrow road section before the oncoming vehicle, when it has been determined that the host vehicle can enter into the narrow road section before the oncoming vehicle.

2. The vehicle control device according to claim 1, wherein the processor is further configured to
determine whether or not the forward moving vehicle will reach the narrow road section before the oncoming vehicle and the host vehicle can enter into the narrow road section before the forward moving vehicle passes through the narrow road section, and
decide that the host vehicle should enter into the narrow road section before the oncoming vehicle, when it has been determined that the forward moving vehicle will reach the narrow road section before the oncoming vehicle and the host vehicle can enter into the narrow road section before the forward moving vehicle passes through the narrow road section.

3. The vehicle control device according to claim 1, wherein the processor is further configured to
determine whether or not the forward moving vehicle will reach the narrow road section before the oncoming vehicle and the host vehicle can enter into the narrow road section before the forward moving vehicle passes beside the oncoming vehicle after having passed through the narrow road section, and
decide that the host vehicle can enter into the narrow road section before the oncoming vehicle, when it has been determined that the forward moving vehicle will pass through the narrow road section before the oncoming vehicle and the host vehicle can enter into the narrow road section before the forward moving vehicle passes beside the oncoming vehicle after having passed through the narrow road section.

4. The vehicle control device according to claim 1, wherein the processor is further configured to
determine whether or not the forward moving vehicle will reach the narrow road section before the oncoming vehicle, the host vehicle can enter into the narrow road section before the forward moving vehicle passes through the narrow road section, and a distance between the forward moving vehicle and the host vehicle is shorter than a predetermined reference distance, and
decide that the host vehicle can enter into the narrow road section before the oncoming vehicle, when it has been determined that the forward moving vehicle will pass through the narrow road section before the oncoming vehicle, the host vehicle can enter into the narrow road section before the forward moving vehicle passes through the narrow road section, and the distance between the forward moving vehicle and the host vehicle is shorter than the predetermined reference distance.

5. The vehicle control device according to claim 1, wherein the processor is further configured to
determine whether or not the forward moving vehicle has decelerated beyond a predetermined reference speed amount after it has been decided that the host vehicle can enter into the narrow road section before the oncoming vehicle,
determine that the host vehicle cannot enter into the narrow road section before the oncoming vehicle, when it has been determined that the forward moving vehicle has decelerated beyond the predetermined reference speed amount, and
decide to cancel the decision allowing the host vehicle to enter into the narrow road section before the oncoming vehicle so that the host vehicle does not enter into the narrow road section before the oncoming vehicle, when it has been determined that the host vehicle cannot enter into the narrow road section before the oncoming vehicle.

6. The vehicle control device according to claim 5, wherein the processor is further configured to determine whether or not the forward moving vehicle has decelerated beyond the predetermined reference speed amount while the forward moving vehicle is traveling in the narrow road section after it has been decided that the host vehicle can enter into the narrow road section before the oncoming vehicle.

7. A computer-readable, non-transitory storage medium storing a computer program for vehicle control, which causes a processor to execute a process, and the process comprises:
determining whether or not a forward moving vehicle traveling ahead of a host vehicle and an oncoming vehicle traveling toward the host vehicle are present in a predetermined range in a traveling direction of the host vehicle,
determining whether or not a narrow road section exists between the forward moving vehicle and the oncoming vehicle where it is difficult for the host vehicle and the oncoming vehicle to travel past each other, when it has been determined that the forward moving vehicle and the oncoming vehicle are present,
determining whether or not the host vehicle can enter into the narrow road section before the oncoming vehicle, based on a response of the forward moving vehicle to the oncoming vehicle, when it has been determined that the narrow road section exists, and
deciding that the host vehicle should enter into the narrow road section before the oncoming vehicle, when it has been determined that the host vehicle can enter into the narrow road section before the oncoming vehicle.

8. A method for controlling a vehicle carried out by a vehicle control device and the method comprises:
determining whether or not a forward moving vehicle traveling ahead of a host vehicle and an oncoming vehicle traveling toward the host vehicle are present in a predetermined range in a traveling direction of the host vehicle,
determining whether or not a narrow road section exists between the forward moving vehicle and the oncoming vehicle where it is difficult for the host vehicle and the oncoming vehicle to travel past each other, when it has been determined that the forward moving vehicle and the oncoming vehicle are present,
determining whether or not the host vehicle can enter into the narrow road section before the oncoming vehicle, based on a response of the forward moving vehicle to the oncoming vehicle, when it has been determined that the narrow road section exists, and
deciding that the host vehicle should enter into the narrow road section before the oncoming vehicle, when it has been determined that the host vehicle can enter into the narrow road section before the oncoming vehicle.
